(19) United States
(12) Patent Application Publication
(10) Pub. No.: US 2010/0026889 A1
(43) Pub. Date: Feb. 4, 2010

(54) Apparatus, Process and Computer Program for Limiting the Vector Length of Colour Vectors

(75) Inventors: Jan Klijn, Breda (NL); Luc Oosterwijk, Eindhoven (NL); Johan Schirris, Veldhoven (NL)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 12/521,072

(22) PCT Filed: Dec. 29, 2006
(86) PCT No.: PCT/EP2006/070264

§ 371 Date: Jun. 24, 2009

(51) Int. Cl. H04N 7/01

(52) U.S. Cl. 348/444; 348/E07.003

(57) ABSTRACT

RGB to NTSC/PAL encoders—as an example—commonly convert red, green and blue colour component signals (RGB) into their corresponding luminance (luma) and chrominance (chroma) signals in the respective standards in order to generate a composite video signal which can be used in connection with television sets and the like. Thereby, roughly spoken, the luminance signal represents the monochrome or black-and-white portion of the composite video signal and the chrominance signal represents the colour portion of the composite video signal. An apparatus 1 for limiting the vector length of colour vectors U, V carrying the chroma information for a composite video signal, is disclosed, which comprises an input module 2 being operable to receive two colour signal values U, V each representing one of the colour vectors, a calculating module 7, 8, 9, 10 being operable to calculate a vector length representative of a chroma vector derived by vector addition of the two colour vectors U, V, a comparator module 13 being operable to compare the vector length representative with a limiting value, a limiting module 11, 14 being operable to limit the vector lengths of the two colour vectors and/or the two colour signal values U, V under the condition that the vector length representative exceeds the limiting value by multiplying the vector lengths and/or the values with the reciprocal value of the vector length of the chroma vector.

### PRIOR ART

This invention relates to an apparatus, a process and a computer program for limiting the vector length of colour vectors. More specifically the invention relates to an apparatus, a process and a computer program for limiting the length of colour vectors carrying the chroma information for a composite video signal.

RGB to NTSC/PAL encoders—as an example—commonly convert red, green and blue colour component signals (RGB) into their corresponding luminance (luma) and chrominance (chroma) signals in the respective standards in order to generate a composite video signal which can be used in connection with television sets and the like. Thereby, roughly spoken, the luminance signal represents the monochrome or black-and-white portion of the composite video signal and the chrominance signal represents the colour portion of the composite video signal.

The signal path for the chrominance signal begins with generating the so-called colour vectors for example U and V or other colour difference signals, whereby the vector length of colour vectors U and V are derived by combining the RGB inputs by the standard transformation:

U=m×(B−Y)

V=n×(R−Y)

with m, n as constants, Y as the value of the luminance signal, B as the value of the blue channel and R as the value of the red channel of the RGB-Signal. Usually the phase of U is defined as 0 degrees phase and the phase of V is perpendicular to the phase of U.

In a next step the two colour vectors U and V are combined by a quadrature amplitude modulation to the chrominance vector or the chrominance signal, respectively.

In modern cameras, colour vectors U and V are commonly limited with a factor of ½*sqrt(2) in order keep the amplitude of the chrominance signal or the vector length of the chrominance vector in a predefined range because otherwise especially saturated colours at phase angles of 45, 135, −45 and −135 degrees may cause annoying colour patterns in the video resulting from the composite video signal. The document PAJ 08191456 A (publication number) seems to disclose such a colour vector limiting process.

### DISCLOSURE OF THE INVENTION

The present invention proposes an apparatus for limiting the vector length of colour vectors carrying the chroma information for a composite video signal with the features of claim 1, a process for limiting the vector length of colour vectors carrying the chroma information for a composite video signal with the features of claim 10 and a respective computer program with the features of claim 11. Preferred embodiments of the invention are disclosed by the dependent claims, the following description and the attached figures.

The proposed apparatus is adapted and/or realised for limiting the vector length of colour vectors carrying the chroma information. The chroma information is preferably defined as the two attributes of a colour: hue and saturation and is displayed on a television set or the like as chrominance.

The apparatus comprises an input module which is adapted and/or realised to receive two colour signal values from two colour signals, whereby each colour signal value or colour signal represents one of the colour vectors. The input module in its most simple expression may be realised as an interface. In other possible realisation it comprises a multiplexer for multiplexing the incoming colour signals in further possible realisations the input module is part of a converting means converting the original colour channel signals, like RGB signals, into the colour signals, and—optional—multiplexing the colour channel and/or the colour signals.

As it is known from the state of the art, the two colour vectors carrying the chroma information and being represented by the two colour signal values can be combined by vector addition to a chroma vector carrying the chroma information. A calculating module of the apparatus is realised and/or adapted to calculate a vector length representative of the chroma vector. Thereby it is possible to generate the chroma vector first and then to calculate the vector length representative or derive the vector length representative directly from the two colour vectors by the known rules of vector addition. Vector length representative means that it is possible to calculate for example the square or a multiple of the vector length in order to facilitate the calculating process and thus to save processing time.

A comparator module as a further part of the apparatus is adapted and/or realised to compare the vector length representative with a limiting value. The limiting value preferably represents a radius of a circular area around the origin in the plane of the two colour vectors and indicates or defines the area in which allowable or legal chroma vectors lie. Allowable or legal chroma vectors are preferably defiled as vectors leading to a chroma signal, which can be displayed by the displaying apparatus, for example the television set especially without generating annoying colour patterns.

A limiting module is adapted and/or realised to limit the vector lengths of the two colour vectors and/or the values of the two colour signals under the condition that the vector length representative exceeds the limiting value. Only in this case the vector lengths and/or values are limited by multiplying them with the reciprocal value of the vector length of the chroma vector. As a generalised concept, the chroma vector is normalized to the vector length corresponding to the radius indicating the circular area in the colour vector plane of allowable chroma vectors. Under the condition that the vector length representative is smaller or equal to the limiting value, the vector lengths of the two colour vectors and/or the values of the two colour signals preferably remain unamended or unchanged.

The underlying idea of the invention is to prevent limiting all colour vectors and/or colour signal values irrespectively whether or not those are too large. The inventors realised that this attenuating of the saturation of all colours with a fixed factor in the colour plane before encoding causes dull colours. In contrast to this, the apparatus according to the invention allows an “intelligent” limiting or clipping of the vectors and/or the signals.

Therefore the advantages of the invention are preferably the prevention of dull colours within the circular area of the colour plane as the generating colour vectors arc not limited or clipped. Furthermore it is secured that the amplitude of colour bursts resulting from over-saturated colours remains within a defined range. As a consequence annoying colour patterns in the composite video are prevented and hue errors caused by clipping of large colour signals are avoided.

In a preferred realisation, the colour vectors are represented in a UV-plane preferably as elucidated in the introductory portion. But also other colour difference signals and/or vectors can be used in connection with the invention as long as each of the base colours R, G and B components (or equivalents) can be derived from the colour difference signal and the luma (Y) signal. Further known and possible colour difference signals are (B-Y; R-Y), (Pr; Pb), (Cr; Cb).

In a further preferred embodiment, the input module is realised and/or coupled with a multiplexer, especially so that the input module receives the colour signal values in a serial and/or clocked order.

In yet a further preferred embodiment the calculating module is realised to calculate the square of the vector length of the chroma vector as the vector length representative. As the two colour vectors are arranged perpendicular to each other, the square of the vector length is calculated as U²+V².

In a practical development the calculating module comprises an optional sign unit, which receives the colour signal values as an input and outputs the absolute value of the colour signal values. It further comprises a square unit which receives the absolute or the original values of the colour signal and outputs the square of the absolute or original values. An adder unit is provided to add the square values of the absolute or original values.

It is furthermore preferred that the comparator module is realised to compare the sum of the square values of the absolute or original values, which represent the square value of the vector length of the chroma vector with a maximum allowable vector length of the colour vector and/or the chroma vector. The maximum allowable vector length preferably corresponds to the square value of the radius of the circular area in the colour vector plane as explained above.

The limiting module is preferably realised to multiply the vector lengths of the colour vectors and/or the values of the colour signals so that a limited chroma vector derived from the limited vector lengths of the colour vectors and/or the limited values of the colour signals has a vector length equal to the maximum allowable vector length. Further preferred is that the limiting module comprises a select unit which is operable to select between the multiplying with the reciprocal value of the vector length and a multiplying with 1, so that in the latter case the vector lengths of the colour vectors and/or the values of the colour signals remain unamended. The select unit is controlled by the result of the comparator module so that multiplying with the reciprocal value is selected in case the vector length representative exceeds the limiting value and the multiplying with 1 in all other cases.

In a practical realisation the apparatus comprises one or more delay units being operable to delay or hold the colour signals, values and/or processed values in order to compensate propagation delays in the modules and or allow a serial processing of the colour signal values.

In a preferred realisation the apparatus is realised as a circuit, preferably comprising two signal branches both starting at the input module and both ending at the limiting module, whereby both branches carry the two colour signal values in a serial manner clocked and/or synchronised by a pixel clock. In a further development, the square value of the vector length of the chroma vector is hold during two pixel clock periods in one of the two branches and the colour signal values are delayed for a corresponding time in the other branch to compensate for the propagation delay during the hold operation in the first branch, which is preferably for one pixel clock period.

A further object of the invention is a process for limiting the vector length of colour vectors carrying the chroma information for a composite video signal according to claim 10, which preferably uses the apparatus according to one of the preceding claims and/or as described above. Alternatively the process may also be performed on a digital processing unit like a computer, microprocessor, DSP and the like.

According to the process, in a first step two colour signal values each representing one of the colour vectors, preferably realised as colour difference values or signals, are received. Preferably the colour signal values are guided into two signal paths.

In the first signal path, a vector length representative of a chroma vector, which is derived by vector addition of the two colour vectors is calculated. The colour signal values are preferably processed sequentially or serially. In order to support sequential or serial processing the colour signal values or intermediate results are hold, especially hold for the duration of two pixel clock pulses or periods. Further preferably the output of the vector length representative is aligned to the phase of the pixel clock.

In a next step, still in the first signal path, the vector length representative is compared with a limiting value, which is preferably defined as the square of the maximum allowable length for the chroma vector.

Under the condition that the vector length representative exceeds the limiting value the two colour vectors and/or the two colour signal values are each multiplied with the reciprocal value of the vector length of the chroma vector. Preferably the reciprocal value of the vector length of the chroma vector is provided by LUT (look-up-table) arranged in the first signal path and the two colour signal values are provided by the second signal path. In order to compensate the holding time in the first signal branch also the signal values of the second signal branch are delayed for a corresponding time, preferably for one pixel clock period.

Yet a further object of the invention is to provide a computer program, which comprises program-code means for performing all the steps of the aforementioned process, when said program is run on a computer and/or on the apparatus as described above or laid down in the preceding claims.

### SHORT DESCRIPTION OF THE DRAWING

Further advantages, features and effects of the present invention are disclosed in the following description and drawings of a preferred embodiment of the invention, whereby the figures show:

FIG. 1 a flow diagram illustrating the signal conversion between RGB signals and composite video signals;

FIG. 2 a coordinate system illustrating the colour vector plane UV;

FIG. 3 a block diagram of an embodiment of the invention;

FIG. 4 a signal plan showing the signals of various test points in the embodiment in FIG. 3 with respect to the pixel clock.

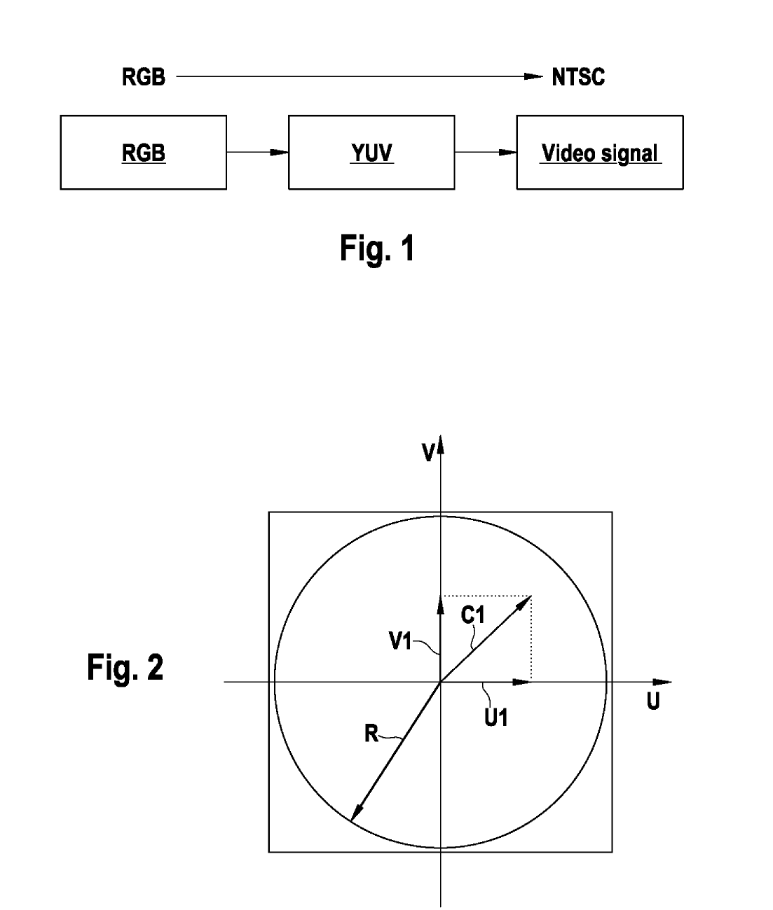

FIG. 1 depicts a signal conversion which is employed in standard RGB to NTSC/PAL encoders, which are used to convert the RGB-signal from a video camera to a NTSC/PAL signal for television sets. Starting with the RGB-signal, which is represented by three signal channels R, G and B for the respective colours components, a first signal conversion is performed to generate intermediate signals, which are used to form the composite video signals. The first conversion is realised by calculating a colour space conversion from the RGB-space into the YUV-space with the conversions equations:

Luma signal Y:

Y=o*R+p*G+q*B and

Colour signal values U, V:

U=m×(B−Y)

V=n×(R−Y)

with m, n, o, p, q as constants and R,B,G as the values of the respective components of the RGB-signal.

In order to generate a chroma vector, which is necessary to form the video composite signal, the colour signal values U, V are interpreted as colour vectors in a UV-plane, which is schematically shown in FIG. 2. The UV-plane is generated by the U and the V-vector, whereby the U-vector is laid off as abscissa and the V-vector is laid off as ordinate. A sample pair of colour vectors is indicated in FIG. 1 by the vectors U1 and V1, which together constitutes the chroma vector C1 which is derived by vector addition of the vectors U1 and V1. The direction (phase, angle) of the chroma vector C1 indicates the hue and the length of the chroma vector C1 indicates the saturation of the resulting colour. The circular area around the origin of the UV-plane with the radius R borders the allowable or legal colour space in the UV-plane, as chroma vectors with a length exceeding the radius R are not converted appropriately any more in the video composite signal and/or not displayed properly on a display unit like a television set.

In the case that the colour signals U, and V are saturated, i.e. that both corresponding colour vectors have a length of R, the resulting chroma vector will become R*sqrt(2) and thus will exceed the circular area. This situation is especially given in case the chroma vector is arranged at 45, 135, −45 and/or −135 degree. Such large colour vectors result into strong clipped colour burst amplitudes after colour encoding and causes annoying colour patterns in the video.

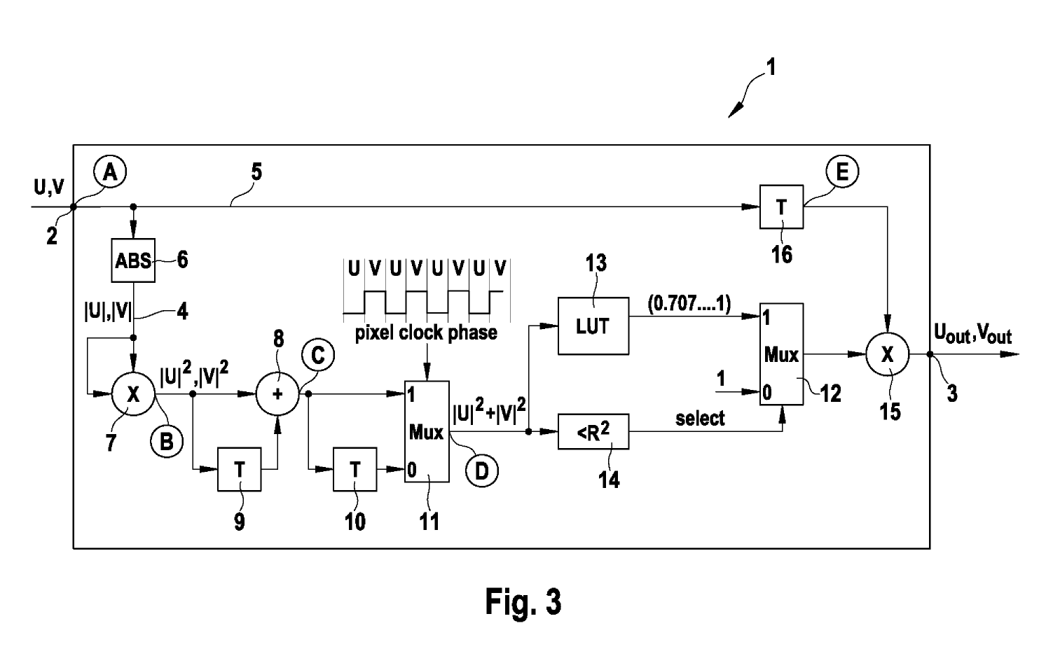

FIG. 3 shows a block diagram of an apparatus 1 or process for limiting the vector length of colour vectors carrying the chroma information for a composite video signal as an embodiment of the invention.

The apparatus 1 is for example realised as an electrical circuit and comprises an input interface 2 for receiving time multiplexed samples of U and V colour signals and an output interface 3 for outputting limited values of the U and V samples, which are indicated as Uout and Vout in FIG. 3.

Starting from the input interface 2 the signal flow is divided in a first signal path 4 and a second signal path 5, both guiding the U and V colour signals.

In a first step in the first signal path 4 the colour signals U and V are made absolute in a sign unit 6, so that in the following the absolute values |U|,|V| of the colour signals U and V are used. In a following step the |U|,|V| values are multiplied by its own, respectively, by a square unit 7 so that intermediate values |U|²,|V|² are generated. In a next step these values are summed by an adder unit 8 supported by a first delay unit 9. In a further step, the resulting value, which represents the square value of the vector length of a chroma vector generated by the present U and V signals, is hold by a second delay unit 10 during two pixel clocks and aligned to the pixel clock phase, which clocks the alternating U and V signals, so that a multiplexer 11 outputs the said square value in phase with the pixel clock.

In the following the signal path 4 is divided into two sub-branches, both ending in a next multiplexer 12.

In the first sub-branch, the square value is fed into a LUT (look-up-table) 13, which outputs a value which equals reciprocal value of the square root (sqrt) of the square value (i.e. the vector length of the chroma vector) and is formulated as 1/\sqrt{|U|²+|V|²}. This value is input to the next multiplexer 12.

In the second sub-branch the square value signal is fed into a comparator module 14, which compares the square value with the square value of the radius R of the circular area as shown in FIG. 2. In case the square value is smaller than the square value of the radius R (, which is R²), the comparator module 14 controls the next multiplexer 12 so that it outputs the value 1. In case the square value is larger than the square value of the radius R, the comparator 14 controls the next multiplexer 12 to output the value which the next multiplexer 12 received from the LUT 13 in the first sub-branch.

The output value (1 for square values smaller than R² and 1/\sqrt{|U|²+|V|²} for square values equal or larger than R²) is transferred to a further multiply module 15, in which also the second signal path 5 ends. The further multiply module multiplies the output value of the next multiplexer 12 with the original U,V signals, which are delayed by a third delay unit 16 in order to compensate the propagation delay in the hold circuit 9 or 10, respectively and generates the output value Uout and Vout.

Summarized the apparatus 1 allows to limit colour signals U and V in a intelligent manner, whereby it is tested whether or not a resulting chroma vector is within a pre-defined allowable or legal colour range in the UV-colour space.

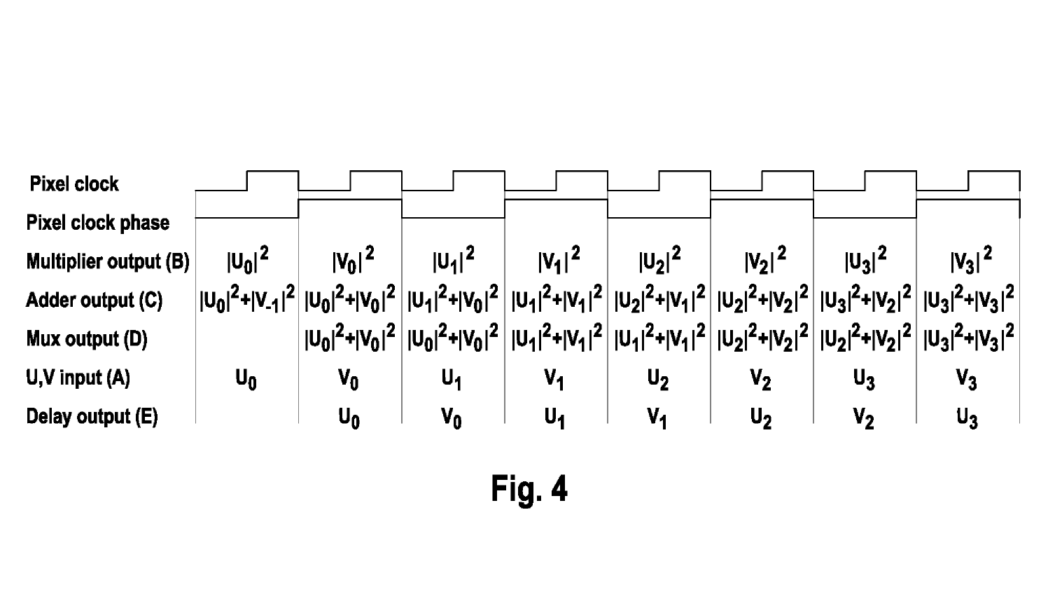

FIG. 4 shows a signal plan illustrating the signals of various test points A, B, C, D and E in the embodiment in FIG. 3 with respect to the pixel clock. In order to get a correct alignment between the multiplexer 11 output (testpoint D) and the U/V input (test point A at the input interface 2), the output of the third delay unit 16 (test point E) is delayed for one pixel period with respect to the input (test point A). The multiplexer 11 output is hold during two pixel clock periods by the first and second delay unit 9 and 10, but the final processing delay in the first signal path 4 is also one pixel clock period.

1. Apparatus (1) for limiting the vector length of colour vectors (U,V) carrying the
chroma information for a composite video signal, the apparatus (1) comprising:
an input module (2) being operable to receive two colour signal values (U,V)
each representing one of the colour vectors,
a calculating module (7, 8, 9, 10) being operable to calculate a vector length representative of a chroma vector derived by vector addition of the two colour vectors (U,V),
a comparator module (13) being operable to compare the vector length representative with a limiting value,
a limiting module (11, 14) being operable to limit the vector lengths of the two colour vectors and/or the two colour signal values (U,V) under the condition that the vector length representative exceeds the limiting value by multiplying the vector lengths and/or the values with the reciprocal value of the vector length of the chroma vector.

2. Apparatus (1) according to claim 1, characterised in that the colour vectors are
represented in the UV-plane, the B-Y/R-Y-plane, the Pr/Pb-plane, Cr/Cb-plane
or equivalent planes.

3. Apparatus (1) according to claim 1, characterised in that the input module (2) is realised as or coupled with a multiplexer unit.

4. Apparatus (1) according to claim 1, characterised in that the calculating module (7, 8, 9, 10) is realised to calculate the square of the vector length of the chroma vector as the vector length representative.

5. Apparatus (1) according to claim 4, characterised in that the calculating module
comprises a sign unit (6) being operable to calculate the absolute values of the colour signal values, a square unit (7) being operable to calculate the square of the absolute value and an adder unit (8) being operable to add the square values of the absolute values.

6. Apparatus (1) according to claim 4, characterised in that the comparator module (13) is realised to compare the square of the vector length with the square value of a maximum allowable vector length of the colour vectors and/or chroma vector.

7. Apparatus (1) according to claim 1, characterised in that the limiting module (11,14) is realised to multiply the vector lengths of the colour vectors and/or the values of the colour signals so that a limited chroma vector derived from the limited vector lengths of the colour vectors and/or the limited values of the colour signals has a vector length equal to the maximum allowable vector length.

8. Apparatus (1) according to claim 1, characterised in comprising one or more delay units (8, 9, 15) being operable to delay the colour signals to compensate propagations delays in the modules.

9. Apparatus (1) according to claim 1, characterised in being realised as an electrical circuit.

10. Process for limiting the vector length of colour vectors carrying the chroma information for a composite video signal, preferably using the apparatus according to claim 1, comprising the steps of:
receiving two colour signal values each representing one of the colour vectors,
calculating a vector length representative of a chroma vector derived by vector addition of the two colour vectors,
comparing the vector length representative with a limiting value and under the condition that the vector length representative exceeds the limiting value limiting the vector lengths of the two colour vectors and/or the colour signal values by multiplying the vector lengths and/or the values with the reciprocal value of the vector length of the chroma vector.

11. Computer program comprising program-code means for performing all the steps of claim 10, when said program is run on a computer and/or on the apparatus.
